(19) United States
(12) Patent Application Publication
(10) Pub. No.: US 2026/0030804 A1
(43) Pub. Date: Jan. 29, 2026

(54) DISPLAY DEVICE, HANDWRITING DISPLAY METHOD, AND HANDWRITING CONTOUR DETERMINATION METHOD

(71) Applicant: BOE Technology Group Co., Ltd., Beijing (CN)

(72) Inventor: Jingru WANG, Beijing (CN)

(21) Appl. No.: 18/996,994

(22) PCT Filed: Oct. 31, 2022
(86) PCT No.: PCT/CN2022/128710

§ 371 Date: Jan. 18, 2025

(51) Int. Cl. G06T 11/20; G06T 5/77; G06V 30/22; G06V 30/32

(52) U.S. Cl. CPC G06T 11/203; G06T 5/77; G06V 30/22; G06V 30/347

(57) ABSTRACT

The present disclosure provides a display device, a handwriting display method and a handwriting contour determination method, for splitting a writing track, and realizing a half-dry stroke writing effect by filling a part of sub-contours in a plurality of split sub-contours and not filling the other sub-contours. The device includes a display screen and a controller, the display screen is configured to display a content; and the controller is configured to: acquire track point information of track points in a writing track of a user; determine a stroke corresponding to the track points according to the track point information of the track points, with the stroke including a stroke contour; divide the stroke contour into K sub-contours, and select a part of sub-contours from the K sub-contours to perform pixel filling on the part of sub-contours, with an extending direction in which the stroke contour extends being the same as an extending direction in which the sub-contours extend, and K being an integer greater than 1; and controlling the display screen to display the stroke.

### TECHNICAL FIELD

The present disclosure relates to the field of data display technology, and particularly relates to a display device, a handwriting display method, and a handwriting contour determination method.

### BACKGROUND

An electronic ink screen, also called an electronic paper display, includes two substrates, on which electronic ink including numerous tiny transparent particles is coated. The particles are formed by many black and white particles with positive and negative electricity, respectively. Since the charged particles with different colors will move towards different directions due to an applied electric field, a black or white effect will appear on a surface of the screen.

In order to meet writing requirements of users, the electronic ink screen is provided with a handwriting function. A large-size intelligent display device is also provided with the handwriting function along with popularization of intelligent conferences. Handwriting tracks may be displayed through the handwriting function in the electronic ink screen or the intelligent display device. Along with expansion of the market of the ink screen and various requirements on the large-size intelligent display device, the requirement for a high-simulation handwriting function is increased more and more.

### SUMMARY

The present disclosure provides a display device, a handwriting display method and a handwriting contour determination method, which are used for splitting a writing track, and realizing a writing effect of a half-dry stroke by filling part of split sub-contours and not filling other split sub-contours.

In a first aspect, an embodiment of the present disclosure provides a display device, which includes a display screen and a controller, the display screen is configured to display a content; and the controller is configured to acquire track point information of track points in a writing track of a user, determine a stroke corresponding to the track points according to the track point information of the track points, with the stroke including a stroke contour, divide the stroke contour into K sub-contours, select a part of sub-contours from the K sub-contours to perform pixel filling on the part of sub-contours, with an extending direction in which the stroke contour extends being the same as an extending direction in which the sub-contours extend, and K being an integer greater than 1, and control the display screen to display the stroke.

In a second aspect, an embodiment of the present disclosure provides a handwriting display method, including: acquiring track point information of track points in a writing track of a user; determining a stroke corresponding to the track points according to the track point information of the track points, with the stroke including a stroke contour; dividing the stroke contour into K sub-contours, and selecting a part of sub-contours from the K sub-contours to perform pixel filling on the part of sub-contours, with an extending direction in which the stroke contour extends being the same as an extending direction in which the sub-contours extend, and K being an integer greater than 1; and controlling the display screen to display the stroke.

In some implementations, there is at least one sub-contour, on which pixel filling is not to be performed, between at least two sub-contours on which pixel filling is to be performed.

In some implementations, the selecting a part of sub-contours from the K sub-contours to perform pixel filling on the part of sub-contours, includes: randomly selecting the part of sub-contours from the K sub-contours to perform pixel filling on the part of sub-contour.

In some implementations, the selecting a part of sub-contours from the K sub-contours to perform pixel filling on the part of sub-contours, includes: selecting the part of sub-contours from the K sub-contours to perform pixel filling on the part of sub-contours, according to generated K random numbers and a corresponding relation between the random numbers and the sub-contours.

In some implementations, the selecting a part of sub-contours from the K sub-contours to perform pixel filling on the part of sub-contours, according to generated K random numbers and a corresponding relation between the random numbers and the sub-contours, includes: calculating a product value of an average value of the K random numbers and a half-dry stroke parameter, with the half-dry stroke parameter being configured to control a total number of the sub-contours on which pixel filling is to be performed; in a case where any random number is greater than the product value, determining to perform pixel filling on the sub-contour corresponding to the random number; and in a case where any random number is less than or equal to the product value, determining not to perform pixel filling on the sub-contour corresponding to the random number.

In some implementations, the half-dry stroke parameter is determined according to a writing speed, and the half-dry stroke parameter is increased along with an increase of the writing speed; and/or the half-dry stroke parameter is determined according to a writing pressure, and the half-dry stroke parameter is increased along with a decrease of the writing pressure.

In some implementations, the selecting a part of sub-contours from the K sub-contours to perform pixel filling on the part of sub-contours, includes: performing pixel filling on the part of sub-contours in different filling manners.

In some implementations, the performing pixel filling on the part of sub-contours in different filling manners, includes: performing pixel filling on the part of sub-contours in different filling manners alternately.

In some implementations, the performing pixel filling on the part of sub-contours in different filling manners alternately, includes: performing pixel filling on the part of sub-contours in a first filling manner and a second filling manner alternately.

In some implementations, the method further includes: dividing continuous sub-contours in the part of sub-contours selected into one contour group, to perform pixel filling on the sub-contours in the contour group at once in a same filling manner.

In some implementations, the performing pixel filling on the sub-contours in the contour group at once in a same filling manner, includes: randomly selecting a filling manner from different filling manners, to perform pixel filling on the sub-contours in the contour group at once in the filling manner selected.

In some implementations, the randomly selecting a filling manner from different filling manners, to perform pixel filling on the sub-contours in the contour group at once in the filling manner selected, includes: randomly selecting the filling manner from the filling manners at a same probability, to perform pixel filling on the sub-contours in the contour group at once in the filling manner selected; or randomly selecting the filling manner from the filling manners at different probabilities, to perform pixel filling on the sub-contours in the contour group at once in the filling manner selected, with the filling manners being in one-to-one correspondence with the probabilities.

In some implementations, the stroke contour of the stroke corresponding to the track points is to be determined by: fitting coordinate information of the track points to obtain a fit curve; selecting a plurality of fit track points from the fit curve, with the plurality of fit track points including at least three first fit track points corresponding to the track points; determining a stroke contour of the plurality of fit track points according to coordinate information of the fit track points and a writing speed and a writing pressure at the track points corresponding to the first fit track points; and taking the stroke contour of the plurality of fit track points as the stroke contour corresponding to the track points.

In some implementations, the determining a stroke contour of the plurality of fit track points according to coordinate information of the fit track points and a writing speed and a writing pressure at the track points corresponding to the first fit track points, includes: determining a position of the stroke contour according to the coordinate information of the plurality of fit track points; and determining a width of the stroke contour according to the writing speed and the writing pressure at the track points corresponding to the first fit track points.

In some implementations, the determining a width of the stroke contour according to the writing speed and the writing pressure at the track points corresponding to the first fit track points, includes: determining line widths at the first fit track points according to a preset maximum line width, a preset minimum line width, a preset weight factor, and the writing speed and the writing pressure at the track points corresponding to the first fit track points, with the preset weight factor indicating a sensitivity parameter of a response adjustment of the line width for different factors; determining line widths at fit track points based on interpolation operation according to the line widths at at least three first fit track points; and determining the width of the stroke contour according to the line widths at the fit track points.

In some implementations, after determining the line widths at the fit track points based on interpolation operation according to the line widths at at least three first fit track points, the method further includes: smoothing the line widths at the fit track points according to first line widths of history fit track points corresponding to history track points of the track points, to obtain smoothed line widths at the fit track points; the historical track points of the track points are a plurality of track points continuously received before receiving the track points; and the historical fit track points corresponding to the historical track points are coordinate points on a fit curve obtained by fitting the historical track points.

In some implementations, the smoothing the line widths at the fit track points according to first line widths of history fit track points corresponding to history track points of the track points, to obtain smoothed line widths at the fit track points, includes: determining the smoothed line widths at the fit track points according to the first line widths at the history fit track points, the line widths at the fit track points and a preset total number of the history fit track points.

In some implementations, the selecting a part of sub-contours from the K sub-contours to perform pixel filling on the part of sub-contours, includes: dividing continuous sub-contours in the part of sub-contours into one contour group, to perform pixel filling on the sub-contours in the contour group at once in a same filling manner.

In some implementations, in the part of sub-contours selected, a total number of the sub-contours on which pixel filling is to be performed continuously is less than a number threshold value; or in the part of sub-contours selected, a total number of the sub-contours on which pixel filling is to be performed continuously in a same filling manner is less than a number threshold value.

In some implementations, a ratio of a total width of the sub-contours on which pixel filling is to be performed to a width of the stroke contour is decreased along with an increase of the writing speed at the track points; or a ratio of a total width of the sub-contours on which pixel filling is not to be performed to the width of the stroke contour is increased along with the increase of the writing speed at the track points.

In some implementations, a ratio of a total width of the sub-contours on which pixel filling is to be performed to a width of the stroke contour is increased along with an increase of the writing pressure at the track point; or a ratio of a total width of the sub-contours on which pixel filling is not to be performed to the width of the stroke contour is decreased along with the increase of the writing pressure at the track point.

In some implementations, a total number of the sub-contours on which pixel filling is to be performed is decreased along with an increase of the writing speed at the track point; or a total number of the sub-contours on which pixel filling is not to be performed is increased along with the increase of the writing speed at the track point. In some implementations, a total number of the sub-contours on which pixel filling is to be performed is increased along with an increase of the writing pressure at the track point; or a total number of the sub-contours on which pixel filling is not to be performed is decreased along with the increase of the writing pressure at the track point.

In some implementations, a density of pixel filling in the stroke contour is decreased along with an increase of the writing speed at the track point; or a density without pixel filling in the stroke contour is increased along with the increase of the writing speed at the track point; the density of pixel filling indicates a ratio of a total number of filled sub-contours to K.

In some implementations, a density of pixel filling in the stroke contour is increased along with an increase of the writing pressure at the track point; or a density without pixel filling in the stroke contour is decreased along with the increase of the writing pressure at the track point; the density of pixel filling indicates a ratio of a total number of filled sub-contours to K.

In some implementations, in a case where the filling manner for the sub-contour includes a scatter filling manner, a probability corresponding to the scatter filling manner is configured to control a total number of the sub-contours on which pixel filling is to be performed in the scatter filling manner; the probability corresponding to the scatter filling manner is increased along with an increase of the writing speed at the track point; and/or the probability corresponding to the scatter filling manner is decreased along with the increase of the writing pressure at the track point.

In some implementations, in a case where the filling manner for the sub-contour includes a scatter filling manner, a scatter density corresponding to the scatter filling manner is decreased along with an increase of the writing speed at the track point; and/or the scatter density corresponding to the scatter filling manner is increased along with the increase of the writing pressure at the track point.

In some implementations, in a case where the stroke is a left-falling stroke, the further a position of the sub-contour in the stroke contour is to left, the less a probability of performing pixel filling on the sub-contour is; or the further the position of the sub-contour in the stroke contour is to right, the greater the probability of performing pixel filling on the sub-contour is.

In some implementations, in a case where the filling manner for the sub-contour is a scatter filling manner and the stroke is a left-falling stroke, the further a position of the sub-contour in the stroke contour is to left, the less a scatter density of scatter filling in the sub-contour is; or, the further the position of the sub-contour in the stroke contour is to right, the greater the scatter density of scatter filling in the sub-contour is.

In some implementations, in a case where the stroke is a right-falling stroke, the further a position of the sub-contour in the stroke contour is to right, the less a probability of performing pixel filling on the sub-contour is; or the further the position of the sub-contour in the stroke contour is to left, the greater the probability of performing pixel filling on the sub-contour is.

In some implementations, in a case where the filling manner for the sub-contour is a scatter filling manner and the stroke is a right-falling stroke, the further a position of the sub-contour in the stroke contour is to right, the less a scatter density of scatter filling in the sub-contour is; or the further the position of the sub-contour in the stroke contour is to left, the greater the scatter density of scatter filling in the sub-contour is.

In some implementations, the dividing the stroke contour into K sub-contours, includes: in a case where a writing speed at the track points is greater than a speed threshold value and/or a writing pressure at the track points is less than a pressure threshold value, dividing the stroke contour into the K sub-contours.

In some implementations, the method further includes: if a total number of the track points exceeds a preset track point number threshold, adjusting a position of the sub-contour on which pixel filling is to be performed.

In some implementations, the adjusting a position of the sub-contour on which pixel filling is to be performed, includes: adjusting positions of a preset number of sub-contours, at an edge of the stroke contour, in the sub-contours on which pixel filling is to be performed.

In a third aspect, an embodiment of the present disclosure further provides a display device, which includes a display screen and a controller, the display screen is configured to display a content; and the controller is configured to acquire track point information of track points in a writing track of a user, determine a writing speed, a writing pressure corresponding to the track points and coordinates of the track points, according to the track point information of the track points, determine line widths corresponding to the track points according to the writing speed and the writing pressure corresponding to the track points, and determine a stroke contour corresponding to the track points, according to the line widths corresponding to the track points and the coordinates of the track points.

In a fourth aspect, an embodiment of the present disclosure further provides a handwriting contour determination method, which includes: acquiring track point information of track points in a writing track of a user; determining a writing speed, a writing pressure corresponding to the track points and coordinates of the track points, according to the track point information of the track points; determining line widths corresponding to the track points according to the writing speed and the writing pressure corresponding to the track points; and determining a stroke contour corresponding to the track points, according to the line widths corresponding to the track points and the coordinates of the track points.

In a fifth aspect, an embodiment of the present disclosure further provides a handwriting display apparatus, including: a track acquisition unit, configured to acquire track point information of track points in a writing track of a user; a contour determination unit, configured to determining a stroke corresponding to the track points according to the track point information of the track points, with the stroke including a stroke contour; a partial filling unit, configured to divide the stroke contour into K sub-contours, and select a part of sub-contours from the K sub-contours to perform pixel filling on the part of sub-contours, with an extending direction in which the stroke contour extends being the same as an extending direction in which the sub-contours extend, and K being an integer greater than 1; and a stroke display unit, configured to control a display screen to display the stroke.

In a sixth aspect, an embodiment of the present disclosure further provides a handwriting contour determination apparatus, including: a track acquisition unit, configured to acquire track point information of track points in a writing track of a user; an information determination unit, configured to determine a writing speed, a writing pressure corresponding to the track points and coordinates of the track points, according to the track point information of the track points; a line width determination unit, configured to determine line widths corresponding to the track points, according to the writing speed and the writing pressure corresponding to the track points; and a contour determination unit, configured to determine a stroke contour corresponding to the track points, according to the line widths corresponding to the track points and the coordinates of the track points.

In a seventh aspect, an embodiment of the present disclosure further provides a computer-readable storage medium storing thereon a computer program, the computer program, executed by a processor, causes the processor to perform steps of the method in the second or fourth aspect.

These and other aspects of the present disclosure will be more readily apparent in the following description of the embodiments.

### BRIEF DESCRIPTION OF DRAWINGS

In order to explain the technical solutions in the embodiments of the present disclosure more clearly, the drawings to be described in the description of the embodiments will be briefly described below. Apparently, the drawings in the following description merely illustrate some embodiments of the present disclosure, and other drawings may be derived from these drawings by those skilled in the art without any creative labor.

FIG. 1 is a schematic diagram illustrating a display device according to an embodiment of the present disclosure.

FIG. 2 is a schematic diagram illustrating drawing a stroke contour according to an embodiment of the present disclosure.

FIG. 3 is a schematic diagram illustrating split sub-contours according to an embodiment of the present disclosure.

FIG. 4 is a diagram illustrating a comparison between a half-dry stroke effect according to an embodiment of the present disclosure and a common track display effect.

FIG. 5 is a schematic diagram illustrating a half-dry stroke effect of a left-falling stroke according to an embodiment of the present disclosure.

FIG. 6 is a schematic diagram illustrating a half-dry stroke effect of a right-falling stroke according to an embodiment of the present disclosure.

FIG. 7 is a schematic diagram illustrating sub-contours obtained by dividing a stroke contour according to an embodiment of the present disclosure.

FIG. 8 is a schematic diagram illustrating a display effect of a hand-written font after being beautified into a half-dry stroke according to an embodiment of the present disclosure.

FIG. 9 is a flowchart of a handwriting display method according to an embodiment of the present disclosure.

FIG. 10 is a schematic diagram illustrating a display device according to an embodiment of the present disclosure.

FIG. 11 is a flowchart of a handwriting contour determination method according to an embodiment of the present disclosure.

FIG. 12 is a schematic diagram illustrating a handwriting display apparatus according to an embodiment of the present disclosure.

FIG. 13 is a schematic diagram illustrating a handwriting contour determination apparatus according to an embodiment of the present disclosure.

### DETAIL DESCRIPTION OF EMBODIMENTS

To make the objects, technical solutions and advantages of the present disclosure more apparent, the present disclosure will be further described in detail below with reference to the drawings. Apparently, the described embodiments are merely some, but not all, of the embodiments of the present disclosure. All other embodiments obtained by those skilled in the art based on the embodiments of the present disclosure described herein without any creative effort shall be considered to be within the protection scope of the present disclosure.

The term “and/or” in the embodiments of the present disclosure describes an association relationship between associated objects, and indicates that three relationships may exist. For example, A and/or B may indicate: A exists alone, A and B exist simultaneously, or B exists alone. The character “/” generally indicates that the associated objects before and after the character “/” are in an “or” relationship.

The application scenes described in the embodiments of the present disclosure are for more clearly illustrating the technical solutions of the embodiments of the present disclosure, and do not form a limitation on the technical solutions according to the embodiments of the present disclosure. As those skilled in the art known, with the occurrence of any new application scene, the technical solutions according to the embodiments of the present disclosure may also be applicable for similar technical problems. In the description of the present disclosure, the meaning of “a plurality” is two or more, unless otherwise specified.

An electronic ink screen, also called an electronic paper display, includes two substrates, on which electronic ink including numerous tiny transparent particles is coated. The particles are formed by many black and white particles with positive and negative electricity, respectively. Since the charged particles with different colors will move towards different directions due to an applied electric field, a black or white effect will appear on a surface of the screen. In order to meet writing requirements of users, the electronic ink screen is provided with a handwriting function. A large-size intelligent display device is also provided with the handwriting function along with popularization of intelligent conferences. Handwriting tracks may be displayed through the handwriting function in the electronic ink screen or the intelligent display device. Along with expansion of the market of the ink screen and various requirements on the large-size intelligent display device, the requirement for a high-simulation handwriting function is increased more and more.

It should be noted that the display device in any embodiment of the present disclosure includes an intelligent interactive display device with a touch and handwriting function. The intelligent display device is installed with a writing program such as a whiteboard, and the user can write on the display device by a finger, an active pen, a passive pen or the like. The intelligent display device may include a display module such as a Liquid Crystal Display (LCD) module, an Organic Light-Emitting Display (OLED) module, an electronic ink display module or the like, and may be an ink screen, and can display, in real time, a writing track.

In the embodiments of the present disclosure, by splitting a stroke contour formed by a writing track, and filling part of split sub-contours and not filling other split sub-contours, a writing effect of a half-dry stroke is realized. The half-dry stroke is a special stroke in calligraphy, with some parts of the stroke resembling withered threads parallel to each other, and thus the stroke, in calligraphy, with half-dry parts is generally called the half-dry stroke, and the stroke shows a hint of whiteness, as is written by a half-dry writing brush.

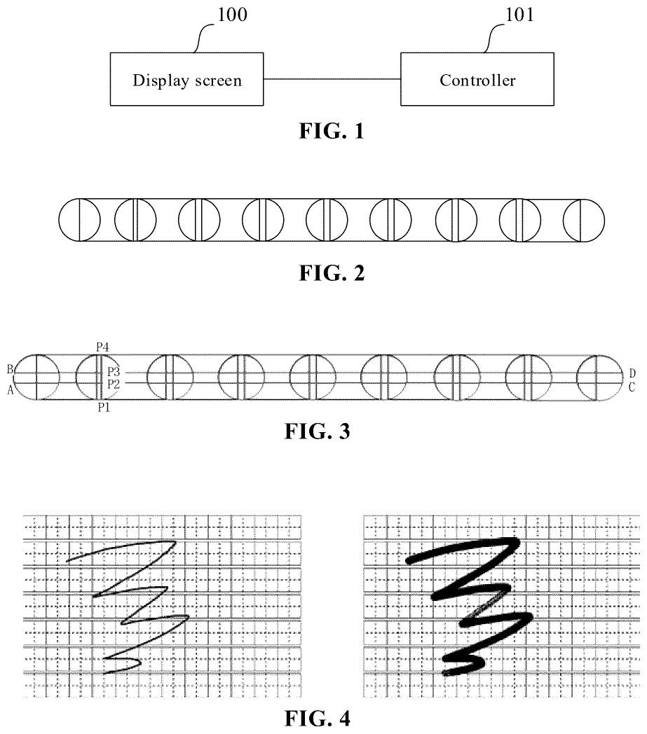

As shown in FIG. 1, an embodiment of the present disclosure provides a display device, which includes a display screen 100 and a controller 101.

The display screen 100 is configured to display a content.

The controller 101 is configured to perform the following steps 1 to 4.

At step 1, acquiring track point information of track points in a writing track of a user.

In implementations, the writing track written by the user is received, the received writing track is sampled, and track point information of a sampled track point at a moment t is obtained.

The track point information may include, but not limited to, track point coordinates, a sampling moment, a track point pressure value, a track point flag, a track point instantaneous speed, and the like. The track point flag is configured to indicate a position of the track point in sampled points, for example, the track point flag indicates that the track point is at a position, in the sampled points, including at least one of a position starting to write, a position in writing or a position stopping to write. The track point instantaneous speed may be obtained by calculating according to sampling moments and track point coordinates corresponding to adjacent track points, respectively.

In the embodiment of the present disclosure, a stroke written by the user may be determined according to an operation of the user starting to write, an operation of the user in writing and an operation of the user stopping to write. For the stroke written by the user, by applying the handwriting display method according to the embodiment of the present disclosure, the stroke is to be displayed with the half-dry stroke effect.

It should be noted that the stroke in the embodiment of the present disclosure is displayed after being filled or rendered, and the writing track in the embodiment of the present disclosure refers to touch point information (i.e., track point information) generated in response to that the user directly writes, with a finger or a writing pen, on a display screen configured with a touch function. After acquiring the writing track, the hardware transfers the writing track to a simulation algorithm, to process the writing track and determine the stroke according to the writing track, thereby displaying the stroke.

In implementations, a writing track of a stroke written by a user is received, track point information of track points in the writing track of the stroke is acquired, the writing track of the stroke is split, to obtain split writing tracks of the stroke, and part of split sub-contours are selected from K split sub-contours and are filled, so that a writing track with the half-dry stroke effect is obtained.

In some implementations, the user may use an electromagnetic pen to write on a screen, and the hardware of the display device acquires writing track point information of the stroke and transfers the writing track point information to a simulation algorithm to be processed. An information array of the sampled track point pointₜ obtained at the moment t is recorded as [xₜ, yₜ, preₜ, t, flagₜ], xₜ, yₜ respectively represent track point coordinates, preₜ indicates the track point pressure value, t indicates the sampling moment, and flagₜ indicates the track point flag.

At step 2, determining a stroke corresponding to the track points according to the track point information of the track points, with the stroke including a stroke contour.

The stroke may further include a pixel filling color and a filling manner for pixel filling, and the filling manner includes, but is not limited to, at least one of full black filling and scatter filling.

In some implementations, before determining the stroke contour corresponding to the track points according to the track point information of the track points, a moving distance of the writing track may be determined according to the track point information of the track points, and if the moving distance is greater than a distance threshold value, the writing track is to be displayed.

In implementations, the moving distance may be calculated for a preset number of consecutive track points in the writing track. For example, for a set of consecutive three track points including pointₜ₋₁, pointₜ, and pointₜ₊₁, the moving distance D of the three track points from pointₜ₋₁ to pointₜ₊₁, that is, the moving distance of the writing track, may be calculated. During calculating, a distance D1 between pointₜ₋₁ and pointₜ, and a distance D2 between point, and pointₜ₊₁ may be calculated, and then D=D1+D2. If D is less than the distance threshold value (e.g., 2), the track points are not to be displayed on the screen, that is, no rendering operation for drawing is to be performed. Until a moment t+n at which the moving distance D of three track points including pointₜ₋₁, pointₜ₊ₙ and pointₜ₊ₙ₊₁ is greater than the distance threshold value, the three track points are taken as a group, and a first track point A, a second track point B and a third track point C in the group are rendered and drawn, that is, are rendered and displayed. In implementations, the track points may be sampled in a sparse sampling manner, so that the amount of calculating is saved. In a case where the user writes slowly, naked eyes actually cannot perceive a change on the screen, and thus, by processing/sampling in this manner, redundant amount of calculating and drawing can be saved, which facilitates to reduce the delay of handwriting.

It should be noted that, in the embodiment of the present disclosure, for calculating the moving distance of the writing track, if a preset number of track points are obtained by sampling, a moving distance of the track points is calculated. For example, after three track points (point₁, point₂, point₃) are obtained by sampling, the moving distance of the three track points is calculated, and if the fourth track point is obtained by sampling, the moving distance of the latest track points (point₂, point₃, point₄) is calculated. That is, the moving distance of the preset number of latest track points obtained by sampling is calculated, and if the moving distance is greater than the distance threshold value, the rendering operation is performed on the preset number of latest track points obtained by sampling.

In some implementations, the stroke contour of the stroke may be determined directly by the track points or may be determined by the track points obtained by sparse sampling, a position of the stroke contour is determined according to coordinate information of the track points, and a width of the stroke contour is determined according to the writing speed and the writing pressure at the track points, so that the stroke contour of the stroke corresponding to the track points is determined. The width of the stroke contour may also be determined according to a fixed line width, and the position of the stroke contour is determined according to the coordinate information of the track points, so that the stroke contour of the stroke corresponding to the track points is determined.

In some implementations, the stroke contour of the stroke corresponding to the track points may also be determined through the following steps (1) to (4).

At step (1), fitting coordinate information of the track points, to obtain a fit curve.

The track points may be fitting with a Bezier curve, to obtain the fit curve. It should be noted that other fitting methods may alternatively be used to fit the track points, which is not limited in the embodiment of the present disclosure.

If a second order Bezier curve is chosen for the fitting method, three track points may be used for fitting, to obtain the fit curve. If a third order Bezier curve is chosen for the fitting method, four track points may be used for fitting, to obtain the fit curve, and so on. If other methods are chosen for the fitting method, the number of the track points may be selected as desired, to perform the fitting, and how to obtain the fit curve is not limited the embodiment of the present disclosure.

In implementations, the first track point A, the second track point B and the third track point C are taken as the track points, a second order Bezier curve is fitted to the three points, and nine fit track points are acquired, with a first one of the fit track points corresponding to the point A, a fifth one of the fit track points corresponding to the point B, and a ninth one of the fit track points corresponding to the point C. It should be noted that the first track point A and the third track point C may be located on the second order Bezier curve, the point B may not be located on the Bezier curve after fitting, and the point B is replaced by the fifth one of the fit track points to perform the subsequent rendering process.

At step (2), selecting a plurality of fit track points from the fit curve, with the plurality of fit track points including at least three first fit track points corresponding to the track points.

The first one, the fifth one and the ninth one of the fit track points on the fit curve may be selected as the first fit track points corresponding to the first track point A, the second track point B and the third track point C, respectively.

At step (3), determining a stroke contour of the plurality of fit track points according to the coordinate information of the plurality of fit track points and the writing speed and the writing pressure at the track points corresponding to the first fit track points.

In some implementations, the stroke contour of the plurality of fit track points is determined by: determining a position of the stroke contour according to the coordinate information of the plurality of fit track points; and determining a width of the stroke contour according to the writing speed and the writing pressure at the track points corresponding to the first fit track points.

In implementations, the position of the stroke contour is first determined according to the coordinate information of the fit track points, and then the width of the stroke contour is determined, the width of the stroke contour is related to the writing speed and the writing pressure at the track points corresponding to the first fit track points. In the embodiment of the present disclosure, during determining the position of stroke contour, as much the coordinate information of the fit track points as possible is desired, and during determining the width of stroke contour, since most of the fit track points on the fit curve are not true track points contained in the writing track of the user, and thus do not have corresponding writing speed and writing pressure, so that the line widths at the first fit track points corresponding to the true track points may be first determined, and then the line widths at the rest of the fit track points may be calculated based on interpolation operation.

The width of the stroke contour may be determined according to the writing speed and the writing pressure at the track points corresponding to the first fit track points by the following steps 3a) to 3c).

At step 3a), determining line widths at the first fit track points according to a preset maximum line width, a preset minimum line width, a preset weight factor, and the writing speed and the writing pressure at the track points corresponding to the first fit track points, with the preset weight factor indicating a sensitivity parameter of a response adjustment of the line width for different factors.

In implementations, taking the second order Bezier curve serving as the fit curve as an example, a first one of the first fit track points corresponds to the point A, a fifth one of the first fit track points corresponds to the point B, a ninth one of the first fit track points corresponds to the point C, the line width at the first one of the first fit track points is determined according to the writing speed and the writing pressure at the point A, the line width at the fifth one of the first fit track points is determined according to the writing speed and the writing pressure at the point B, and the line width at the ninth one of the first fit track points is determined according to the writing speed and the writing pressure at the point C.

In implementations, the writing speed and the writing pressure may be determined by: determining the writing speed corresponding to the first fit track point according to the track point coordinates and the sampling moment in the track point information of the track point corresponding to the first fit track point; and determining the writing pressure corresponding to the first fit track point according to the track point pressure in the track point information of the track point corresponding to the first fit track point.

At step 3b), determining line widths at the fit track points, based on interpolation operation, according to the line widths at at least three first fit track points.

The line widths corresponding to the other fit track points on the fit curve except the first fit track points are determined, based on a linear interpolation method, according to the line widths corresponding to the first fit track points.

The line widths corresponding to the other six fit track points are calculated, based on a linear interpolation method, according to line widths respectively corresponding to the first one of the first fit track points, the fifth one of the first fit track points and the ninth one of the first fit track points.

In implementations, the following formula may be adopted to determine the line width corresponding to the first fit track point:

$$lineWidth = maxLW - {α}_{speed} \times {( \frac{speed}{{β}_{speed}} )}^{{γ}_{speed}} - {α}_{pressure} \times \frac{{( maxLW - minLW )}^{{γ}_{pressure}}}{1 + {e}^{{β}_{pressure} \times ( 0.5 - pressure )}} . \qquad formula ( 1 )$$

In the formula (1), maxLW is the preset maximum line width, minLW is the preset minimum line width, speed is the writing speed at the track point corresponding to the first fit track point, pressure is a writing pressure normalization value at the track point corresponding to the first fit track point, and is a value in a range from 0 to 1.

α_{speed}, β_{speed}, γ_{speed}, αₚᵣₑₛₛᵤᵣₑ, βₚᵣₑₛₛᵤᵣₑ and γₚᵣₑₛₛᵤᵣₑ are preset weight factors which indicate sensitivity parameters of response adjustments of the line width for different factors, and the preset weight factors may be modified through sliding a numerical bar by the user at a front end, so that self-defined writing effect adjustment is supported.

At step 3c), determining the width of the stroke contour according to the line widths at the fit track points.

In implementations, after the line widths corresponding to the fit track points are determined, the width of the stroke contour is determined, the width of the stroke contour determined in this way is changed along with the writing speed and the writing pressure at the track point, and compared with the stroke contour with a fixed width, the display effect is more real.

In some implementations, after the line widths corresponding to the fit track points are determined, the line widths at the fit track points may be smoothed according to first line widths at history fit track points corresponding to history track points of the track points, to obtain smoothed line widths.

The line widths at the fit track points, determined based on interpolation operation according to the line widths at the at least three first fit track points, may be smoothed by: smoothing the line widths at the fit track points according to first line widths at history fit track points corresponding to history track points of the track points, to obtain the line widths at the fit track points.

The historical track points of the track points are a plurality of track points continuously received before receiving the track points; and the historical fit track points corresponding to the historical track points are coordinate points on a fit curve obtained by fitting the historical track points.

The smoothed line widths at the fit track points may be determined according to the first line widths at the history fit track points, the line widths at the fit track points and a preset number of the history fit track points.

In the embodiment of the present disclosure, in order to ensure that a saw teeth effect is not to be generated due to a drastic change in line width during writing, the line widths at the fit track points may be determined and then smoothed according to the following formula:

$$\overline{{lineWidth}_{t}} = {\sum }_{i = 0}^{wLen} \frac{2 \times ( wLen - i ) \times {lineWidth}_{t - i}}{wLen \times ( wLen + 1 )} . \qquad formula ( 2 )$$

In the formula (2), wLen is a window length set for a sliding average, i.e., the number of preset historical fit track points, l̅i̅n̅e̅W̅i̅d̅t̅h̅ₜ̅ indicates the smoothed line width at the fit track point corresponding to a sampling moment t, lineWidthₜ₋ᵢ indicates the line width at the fit track point corresponding to a sampling moment t−i, and i is an integer. For example, wLen is equal to 5, that is, the line widths at the current fit track point and the historical fit track points corresponding to four historical track points before the current track point are used to determine the smoothed line width at the current fit track point.

The smoothed line widths at the first one of the first fit track points, the fifth one of the first fit track points and the ninth one of the first fit track points are obtained through the formula (2), and then the line widths at the other six fit track points are calculated, based on a linear interpolation method, according to the smoothed line widths of the first one of the first fit track points, the fifth one of the first fit track points and the ninth one of the first fit track points.

At step (4), taking a stroke contour of the plurality of fit track points as the stroke contour corresponding to the track points.

For each track point, a preset graph may be drawn according to the line width corresponding to the track point by taking the track point as a center, to obtain the preset graph corresponding to the track point. The stroke contour corresponding to the track points is determined according to preset graphs corresponding to the track points.

In some implementations, the preset graph is a circle. In the embodiment of the present disclosure, the stroke contour corresponding to the fit track points is determined according to the line widths corresponding to the fit track points and coordinates of the fit track points by the following steps: i) for each fit track point, drawing a circle by taking the coordinates of the fit track point as a center of the circle and taking the line width corresponding to the fit track point as a diameter of the circle, to obtain the circle corresponding to the fit track point; ii) determining external common tangent points of adjacent circles in the circles corresponding to the fit track points; and iii) sequentially connecting the external common tangent points in a clockwise direction or an anticlockwise direction, to obtain the stroke contour corresponding to the fit track points.

As shown in FIG. 2, a schematic diagram illustrating drawing a stroke contour according to the embodiment of the present disclosure is illustrated. By taking nine fit track points as an example, a circle is drawn for each fit track point by taking the coordinates of the fit track point as a center of a circle, and taking the line width corresponding to the fit track point as a diameter of the circle, thereby obtaining nine circles, four external common tangent points between adjacent circles are calculated, and the external common tangent points are sequentially connected in the clockwise direction or the counterclockwise direction, to obtain the stroke contour corresponding to the fit track points. Currently, for drawing the track, the four external common tangent points between the adjacent circles are calculated, and form a connecting quadrangle to be drawn, so that a relatively large overlapping area exists between each circle and the connecting quadrangle, resulting in much redundant drawing, and the response speed of the system is slowed. In order to solve this problem, drawing is to be performed at positions of the first circle and the last circle, and vertexes of eight connecting quadrilaterals are arranged clockwise, to draw a polygon formed by thirty two points.

At step 3, dividing the stroke contour into K sub-contours, and selecting a part of sub-contours from the K sub-contours to perform pixel filling on the part of sub-contours, with an extending direction in which the stroke contour extends being the same as an extending direction in which the sub-contours extend, and K being an integer greater than 1.

At step 4, controlling a display screen to display the stroke.

It should be noted that, in the embodiment of the present disclosure, the extending direction in which the stroke contour extends is consistent with the actual writing direction by the user. For example, if the user writes a Chinese character “ [symbol] ” from left to right, the extending direction of the stroke is the direction from left to right, and if the user writes an Arabic numeral “1” from top to bottom, the extending direction of the stroke is the direction from top to bottom, and so on. In the embodiment of the present disclosure, the extending directions of the stroke contour and the sub-contour are determined based on the writing direction by the user during writing the stroke.

In some implementations, if the writing speed is greater than a speed threshold value and the writing pressure is less than a pressure threshold value, the stroke contour is divided into K sub-contours, the writing speed and the writing pressure are determined according to the track point information of the track points.

The track point instantaneous speed at a middle track point among the track points may be selected as the writing speed, and the track point pressure at the middle track point may be selected as the writing pressure. Alternatively, an average speed of track point instantaneous speeds at the track points may be selected as the writing speed, and an average pressure of track point pressures at the track points may be selected as the writing pressure. In the embodiment of the present disclosure, how to determine the writing speed and the writing pressure is not limited.

In implementations, the stroke contour is divided into K sub-contours, and coordinates of a split point obtained by dividing a circular contour corresponding to each track point are determined by the following formulas:

$${x}_{i} = {circle}_{x} - consine ( 90 - \frac{180 \times i}{K} + angle ) \times radius ; \qquad formula ( 3 )$$

$${y}_{i} = {circle}_{y} - sine ( 90 - \frac{180 \times i}{K} + angle ) \times radius . \qquad formula ( 4 )$$

In the formulas, xᵢ and yᵢ are respectively horizontal and vertical coordinates of a split point of an i^{th} sub-contour obtained by dividing the circular contour of the first one of the first fit track points, circleₓ and circle_{y} are respectively horizontal and vertical coordinates of the first one of the first fit track points, and angle is an anticlockwise included angle between a connecting line of the fifth and first ones of the first fit track points in each group of track points and a horizontal direction; and radius is half of the line width corresponding to the first one of the first fit track points.

In the embodiment of the present disclosure, the coordinates of the split point may be located on or in the circle corresponding to the fit track point, which is not limited in the embodiment of the present disclosure. It should be noted that, for convenience of calculation, the coordinates of the split point calculated according to the above formulas (3) and (4) are located on a line segment formed by common tangent points on the circle, and two common tangent points forming the line segment are common tangent points of the same circle. Except the first and ninth ones of the first fit track points, each of the circles corresponding to other fit track points has four common tangent points, and two common tangent points forming the line segment are the common tangent points of the same circle, so that two line segments can be formed, and the split point may be the point on any one of the line segments, which is not limited in the embodiment of the present disclosure.

Similarly, the horizontal and vertical coordinates of the split point of the i^{th} sub-contour obtained by dividing the circular contour of the ninth one of the first fit track points are calculated according to the formulas (3) and (4).

A set of split points of the i^{th} sub-contour are calculated by the following formulas:

$${x}_{p 2} = \frac{( K - ( i - 1 ) ) \times {x}_{p 1} + ( i - 1 ) \times {x}_{p 4}}{K} ; \qquad formula ( 5 )$$

$${y}_{p 2} = \frac{( K - ( i - 1 ) ) \times {y}_{p 1} + ( i - 1 ) \times {y}_{p 4}}{K} ; \qquad formula ( 6 )$$

$${x}_{p 3} = \frac{( K - i ) \times {x}_{p 1} + i \times {x}_{p 4}}{K} ; \qquad formula ( 7 )$$

$${y}_{p 3} = \frac{( K - i ) \times {y}_{p 1} + i \times {y}_{p 4}}{K} . \qquad formula ( 8 )$$

In the above formula, the calculation method of other split points on the sub-contour are given by taking the circular contour of the second one of the first fit track points as an example, and points P1 and P4 are the common tangent points of the circular contour of the second one of the first fit track points and the circular contour of the third one of the first fit track points, the coordinates of the point P1 are (xₚ₁, yₚ₁), and the coordinates of the point P4 are (xₚ₄, yₚ₄); the coordinates of the point P2 are (xₚ₂, yₚ₂), and the coordinates of the point P3 are (xₚ₃, yₚ₃); K is the number of sub-contours, and i is a value in a range from 0 to K.

As shown in FIG. 3, a schematic diagram illustrating split sub-contours is illustrated, points A and B are the (i−1)^{th} and i^{th} split points on the first circle, respectively, and points C and D are the (i−1)^{th} and i^{th} split points on the last circle, respectively. The points P1 and P4 are the common tangent points of the second circle and the third circle, the points P2 and P3 are calculated through the formula (5) to (8). Similarly, the coordinates of other split points are calculated, and are arranged anticlockwise from the point A, to form the split sub-contour.

In some implementations, there is at least one sub-contour on which pixel filling is not to be performed between at least two sub-contours on which pixel filling is to be performed. The half-dry stroke effect can be created by filled and unfilled sub-contours.

In some implementations, alternatively, a part of sub-contours may be randomly selected from the K sub-contours to perform pixel filling on the part of sub-contours; or a part of sub-contours may be selected from the K sub-contours to randomly perform pixel filling on the part of sub-contours.

In some implementations, the pixel filling may be performed on the sub-contour by: selecting a part of sub-contours from the K sub-contours to perform pixel filling on the part of sub-contours, according to generated K random numbers and a corresponding relation between the random numbers and the sub-contours.

The number and positions of the sub-contours on which pixel filling is to be performed may be calculated specifically as follows:
(1) calculating a product value of an average value of the K random numbers and a half-dry stroke parameter, with the half-dry stroke parameter being configured to control the number of the sub-contours on which pixel filling is to be performed;
(2) if any random number is greater than the product value, determining to perform pixel filling on the sub-contour corresponding to the random number; and
(3) if any random number is less than or equal to the product value, determining not to perform pixel filling on the sub-contour corresponding to the random number.

In implementations, a random number array with a length of K in a range of [0, 100] may be generated, and an average value of the array is calculated as r̅a̅n̅d̅. For an i^{th} sub-contour obtained by dividing, if an i^{th} value in the random number array is greater than α×r̅a̅n̅d̅, the interior of the sub-contour is filled, otherwise, the sub-contour is not to be filled, a is the half-dry stroke parameter for controlling a density of a half-dry stroke region, and the greater the value of a is, the sparser a density of black in the generated half-dry stroke region is; the less the value of a is, the denser the density of black in the generated half-dry stroke region is. The value of a may be modified through sliding a numerical bar by the user at the front end, so that self-defined writing effect adjustment is supported.

As shown in FIG. 4, a diagram illustrating a comparison between the half-dry stroke effect according to the embodiment of the present disclosure and a common track display effect is illustrated, the left side is the original handwriting without half-dry stroke beautification, and the right side is the handwriting with half-dry stroke beautification.

In some implementations, the half-dry stroke parameter is related to the following content.

In a first type, the half-dry stroke parameter is determined according to the writing speed, and the half-dry stroke parameter is increased along with the increase of the writing speed.

In a second type, the half-dry stroke parameter is determined according to the writing pressure, and the half-dry stroke parameter is increased along with the decrease of the writing pressure.

In a third type, the half-dry stroke parameter is determined according to the writing speed and the writing pressure, is increased along with the increase of the writing speed, and is increased along with the decrease of the writing pressure.

In implementations, the half-dry stroke parameter may be determined by the following formula:

$$α = {param}_{1} \times {speed}^{{param}_{2}} - \frac{{param}_{3}}{1 + {e}^{{param}_{4} \times ( 0.5 - pressure )}} . \qquad formula ( 9 )$$

In the above formula, param₁, param₂, param₃ and param₄ are control parameters; speed is the writing speed, pressure is the writing pressure, and a is the half-dry stroke parameter; a is increased along with the increase of the speed, to control the number of the sub-contours, which are not to be filled, to be increased; a is increased along with the decrease of the pressure, to control the number of the sub-contours, which are not to be filled, to be increased.

In some implementations, the part of sub-contours selected from the K sub-contours are filled by: performing pixel filling on the selected part of sub-contours in different filling manners.

The pixel filling may be performed on the selected part of sub-contours in different filling manners alternately.

It should be noted that, in the embodiment of the present disclosure, the filling manners are alternated, for example, full black filling, scatter filling, full black filling, scatter filling . . . are performed alternately, and a total number of continuous sub-contours to be filled in the same filling manner may be one or more, which is not limited in the embodiment of the present disclosure.

The pixel filling may be performed by: performing pixel filling on the selected part of sub-contours in a first filling manner and a second filling manner alternately.

If the first filling manner is black filling and the second filling manner is scatter filling, all sub-contours on which pixel filling is to be performed may be first filled in scatter filling, and then the sub-contours filled in scatter filling are covered and filled with black according to an alternate filling manner, so that the scatter filling manner and the black filling manner are alternately performed, the filling times can be reduced, and the calculation amount can be reduced.

In implementations, a difference between the first filling manner and the second filling manner in the embodiment of the present disclosure lies in at least one of differences in terms of a filled pixel value, a filled pixel brightness, a filled pixel color and a filled pixel position. The filling manner in the embodiment of the present disclosure includes, but is not limited to, full black filling, scatter filling, stripe filling, pattern filling, color filling, or the like, and the first filling manner and the second filling manner in the embodiment of the present disclosure may be two different filling manners selected from the above filling manners, which is not limited in the embodiment of the present disclosure.

The first filling manner in the embodiment of the present disclosure may be full black filling, and the second filling manner may be random scatter filling, or the second filling manner may be full black filling, and the first filling manner may be random scatter filling, which is not limited in the embodiment of the present disclosure. It should be noted that the full black filling manner and the random scatter filling manner in the embodiment of the present disclosure are only examples, and other types of filling manners also fall within the protection scope of the present disclosure.

The filling manner includes, but is not limited to, filling with different colors, scatter filling, line filling, curve filling, pattern filling, or the like, which is not limited in the embodiment of the present disclosure.

In order to further simulate the texture effect of ink in the half-dry stroke of a writing brush, the split sub-contours may be partially filled with full black, and partially filled with random scatter in the interior of the sub-contour, so that a richer texture effect is realized. In implementations, the full black filling manner and random scatter filling manner may be used alternately, and the random scatter filling is firstly performed on the selected sub-contours, and then black filling is covered on a part of the sub-contours subjected to the scatter filling, based on the alternate filling manner, so that the computation amount is reduced.

In some implementations, consecutive sub-contours in the selected part of sub-contours may be further divided into one contour group, and pixel filling is performed on the sub-contours in the contour group at once in the same filling manner.

The pixel filling may be performed on the sub-contours in the contour group at once in the same filling manner by: randomly selecting a filling manner from different filling manners, to perform the pixel filling on the sub-contours in the contour group at once in the filling manner.

In implementations, continuous sub-contours in the part of sub-contours are divided into one contour group, and a filling manner is randomly selected to perform pixel filling on the sub-contours in the contour group at once. Specifically, a generated random number array may be used to specify which sub-contours are to be filled as non-white regions. For these sub-contours, either full black filling or random scatter filling is selected to be performed on the sub-contours.

In some implementations, the selecting a part of sub-contours from the K sub-contours to perform pixel filling on the part of sub-contours, specifically includes: dividing continuous sub-contours in the selected part of sub-contours into one contour group, and perform pixel filling on the sub-contours in the contour group at once in the same filling manner.

During actual filling, the selected sub-contours to be filled may be grouped, the continuous sub-contours are grouped into the same group, and then pixel filling is performed on the sub-contours in the same group at once, so that the filling times are reduced.

In some implementations, the number of sub-contours on which pixel filling is to be performed continuously may be further limited. In the selected part of sub-contours, the number of sub-contours on which pixel filling is to be performed continuously is less than a number threshold value.

Alternatively, in the selected part of sub-contours, the number of sub-contours on which pixel filling is to be performed continuously in the same filling manner is less than a number threshold value.

In implementations, by limiting the number of the sub-contours to be continuously filled, if pixel filling is performed on a plurality of continuous sub-contours in the same filling manner, a relatively large region the same is prevented from being generated after the sub-contours being filled, and the half-dry stroke effect is improved.

The filling manner is to be randomly selected to perform pixel filling on the sub-contours in the contour group by the following steps: if the number of the sub-contours in the contour group is less than a number threshold value, randomly selecting a filling manner to perform pixel filling on the sub-contours in the contour group; if the number of the sub-contours in the contour group is greater than or equal to the number threshold value, continuing to divide the contour group, such that the number of the sub-contours in each divided first contour group is less than the number threshold value, and randomly selecting a filling manner to perform filling on the sub-contours in the first contour group.

In some implementations, pixel filling is to be performed on the sub-contours in the contour group at once by randomly selecting a filling manner from different filling manners, in any one or more of the following manners: randomly selecting a filling manner from a plurality of filling manners with a same probability, to perform pixel filling on the sub-contours in the contour group at once in the filling manner; or randomly selecting a filling manner from a plurality of filling manners with different probabilities, to perform pixel filling on the sub-contours in the contour group at once in the filling manner, and the filling manners are in one-to-one correspondence with the probabilities.

In implementations, taking a case where the filling manner is randomly selected from the plurality of filling manners with the same probability, and the sub-contours in the contour group are filled with the selected filling manner, as an example, the step of selecting the filling manner is as the following steps a to c.

At step a, dividing a plurality of continuous sub-contours to be filled into a group, for example, dividing third, fourth and fifth sub-contours into a first group, dividing seventh, eighth, ninth, tenth, eleventh, twelfth and thirteenth sub-contours into a second group, and dividing fifteenth, sixteenth, seventeenth, eighteenth and nineteenth sub-contours into a third group.

At step b, for groups divided in the step a, if the number of the sub-contours in the contour group is not greater than 3, randomly and equiprobably selecting a filling manner, and filling all the sub-contours in the group in this manner.

At step c, for the groups divided in the step a, if the number of the sub-contours in the group exceeds three, continuously dividing the group of sub-contours, such that the number of each divided group of sub-contours does not exceed three. As in step a, the seventh, eighth, ninth, tenth, eleventh, twelfth and thirteenth sub-contours may be divided into a group of seventh, eighth and ninth sub-contours, a group of tenth and eleventh sub-contours and a group of twelfth and thirteenth sub-contours. For each divided first contour group, a filling manner is randomly and equiprobably selected, and all sub-contours in the first contour group are filled in this manner.

In some implementations, a ratio of a total width of the sub-contours on which pixel filling is to be performed to a width of the stroke contour is decreased along with the increase of the writing speed at the track points; or, a ratio of a total width of the sub-contours on which pixel filling is not to be performed to the width of the stroke contour is increased along with the increase of the writing speed at the track points.

In some implementations, the ratio of the total width of the sub-contours on which pixel filling is to be performed to the width of the stroke contour is increased along with the increase of the writing pressure at the track points; or, the ratio of the total width of the sub-contours on which pixel filling is not to be performed to the width of the stroke contour is decreased along with the increase of the writing pressure at the track points.

In the embodiment of the present disclosure, the ratio of the total width of the sub-contours on which pixel filling is to be performed to the width of the stroke contour is decreased with the increase of the writing speed at the track points, and is increased with the increase of the writing pressure at the track points; and the ratio of the total width of the sub-contours on which pixel filling is not to be performed to the width of the stroke contour is increased along with the increase of the writing speed at the track points, and is decreased along with the increase of the writing pressure at the track points.

In some implementations, the number of sub-contours on which pixel filling is to be performed is decreased along with the increase of the writing speed at the track points; or, the number of sub-contours on which pixel filling is not to be performed is increased along with the increase of the writing speed at the track points.

In some implementations, the number of sub-contours on which pixel filling is to be performed is increased along with the increase of the writing pressure at the track points; or, the number of sub-contours on which pixel filling is not to be performed is decreased along with the increase of the writing pressure at the track points.

In some implementations, the number of sub-contours on which pixel filling is to be performed is decreased along with the increase of the writing speed at the track points, and is increased along with the increase of the writing pressure at the track points; and the number of sub-contours on which pixel filling is not to be performed is increased along with the increase of the writing speed at the track points and is decreased along with the increase of the writing pressure at the track points.

In some implementations, a density of pixel filling in the stroke contour is decreased along with the increase of the writing speed at the track points; or, a density without pixel filling in the stroke contour is increased along with the increase of the writing speed at the track points; the density of pixel filling indicates a ratio of the number of filled sub-contours to K.

In some implementations, the density of pixel filling in the stroke contour is increased along with the increase of the writing pressure at the track points; or, the density without pixel filling in the stroke contour is decreased along with the increase of the writing pressure at the track points; the density of pixel filling indicates a ratio of the number of filled sub-contours to K.

In some implementations, the density of pixel filling in the stroke contour is decreased along with the increase of the writing speed at the track points, and is increased along with the increase of the writing pressure at the track points; and the density without pixel filling in the stroke contour is increased along with the increase of the writing speed at the track points, and is decreased along with the increase of the writing pressure at the track points.

In some implementations, in a case where the filling manner of the sub-contour includes scatter filling, the probability corresponding to the scatter filling is configured to control the number of the sub-contours to be filled by the scatter filling; the probability corresponding to the scatter filling is increased along with the increase of the writing speed at the track points; and/or the probability corresponding to the scatter filling is decreased along with the increase of the writing pressure at the track points.

In some implementations, in a case where the filling manner of the sub-contour includes scatter filling, a scatter density corresponding to the scatter filling is decreased along with the increase of the writing speed at the track points; and/or the scatter density corresponding to the scatter filling is increased along with the increase of the writing pressure at the track points.

In some implementations, in a case where the filling manner is scatter filling, the probability corresponding to the scatter filling is configured to control the number of the sub-contours to be filled by the scatter filling. In the embodiment of the present disclosure, the probability of the scatter filling is determined by any one of the following methods 1 to 3.

In the method 1, the probability corresponding to the scatter filling is determined according to the writing speed, and the probability is increased along with the increase of the writing speed.

In the method 2, the probability corresponding to the scatter filling is determined according to the writing pressure, and the probability is increased along with the decrease of the writing pressure.

In the method 3, the probability corresponding to the scatter filling is determined according to the writing speed and the writing pressure, and the probability is increased along with the increase of the writing speed and is increased along with the decrease of the writing pressure.

Random scatter filling may be selected to be used with a probability P, and full black filling is selected to be used with a probability 1-P. The formula of the probability P of the random scatter filling is related to the writing speed and the writing pressure as follows:

$$P = \frac{speed}{{param}_{1}} - \frac{pressure}{{param}_{2}} , s . t . P ∈ ( 0 , 1 ) ; \qquad formula ( 10 )$$

param₁ and param₂ are control parameters, speed is the writing speed, pressure is the writing pressure, and P is the probability of the random scatter filling. P is increased along with the increase of the writing speed, and controls the number of the sub-contours, to be filled by the random scatter filling, to be increased; P is increased along with the decrease of the writing pressure, and controls the number of the sub-contours, to be filled by the random scatter filling, to be increased.

In some implementations, the stroke contour is divided into K sub-contours if the writing speed at the track points is greater than a speed threshold value and/or the writing pressure at the track points is less than a pressure threshold value.

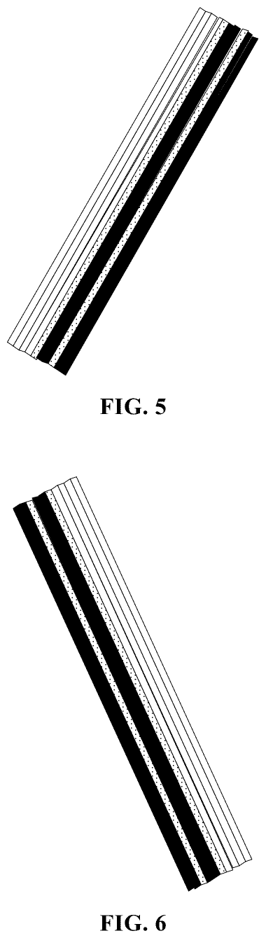

In some implementations, in a case where the stroke is a left-falling stroke, the further a position of the sub-contour in the stroke contour is to left, the less the probability of performing pixel filling on the sub-contour is; or, the further the position of the sub-contour in the stroke contour is to right, the greater the probability of performing pixel filling on the sub-contour is. As shown in FIG. 5, a schematic diagram illustrating a half-dry stroke display effect of a “left-falling” stroke is illustrated, and if the user writes the “left-falling” stroke, the half-dry stroke regions on the upper left of the “left-falling” stroke are more than the half-dry stroke regions on the lower right, so that the half-dry stroke effect of the writing brush can be simulated more truly.

In some implementations, in a case where the filling manner of the sub-contour is scatter filling and the stroke is the left-falling stroke, the further the position of the sub-contour in the stroke contour is to left, the less the scatter density of the scatter filling performed on the sub-contour is; or, the further the position of the sub-contour in the stroke contour is to right, the greater the scatter density of the scatter filling performed on the sub-contour is.

In some implementations, in a case where the stroke is a right-falling stroke, the further a position of the sub-contour in the stroke contour is to right, the less the probability of performing pixel filling on the sub-contour is; or, the further the position of the sub-contour in the stroke contour is to left, the greater the probability of performing pixel filling on the sub-contour is. As shown in FIG. 6, a schematic diagram illustrating a half-dry stroke display effect of a right-falling stroke is illustrated, and if the user writes the “left-falling” stroke, the half-dry stroke regions on the upper right of the “left-falling” stroke are more than the half-dry stroke regions on the lower left, so that the half-dry stroke effect of the writing brush can be simulated more truly.

In some implementations, in a case where the filling manner of the sub-contour is scatter filling and the stroke is the right-falling stroke, the further the position of the sub-contour in the stroke contour is to right, the less the scatter density of the scatter filling performed on the sub-contour is; or, the further the position of the sub-contour in the stroke contour is to left, the greater the scatter density of the scatter filling performed on the sub-contour is.

In implementations, an influence of the stroke direction on the filling of the K sub-contours is constructed. Taking the left-falling stroke as an example, the number of the sub-contours, on which scatter filling is to be performed or pixel filling is not to be performed, at the left side of the stroke is greater than the number of the sub-contours, on which scatter filling is to be performed or pixel filling is not to be performed, at the right side of the stroke, and the probability of the pixel filling is specifically calculated as follows.

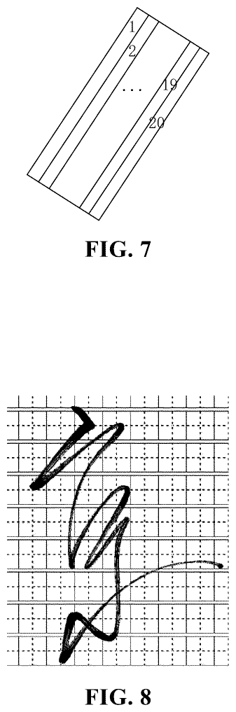

A counterclockwise included angle between a moving direction defined by two adjacent points and the horizontal direction is calculated, and if the included angle is in a range from 90 degrees to 180 degrees, it indicates that the stroke is a left-falling stroke. As shown in FIG. 7, the sub-contours obtained by dividing the stroke contour are illustrated, and the sub-contours are arranged in order from top left to bottom right. Whether the sub-contour is not to be filled is to be determined with a probability P1, and whether random scatter filling is selected for the sub-contour is to be determined with a probability P2. The probability is calculated as follows:

$${P}_{1} = 1 - {( idx / K )}^{{param}_{1}} , {P}_{2} = 1 - {( idx / K )}^{{param}_{2}} ; \qquad formula ( 11 )$$

K is the number of the sub-contours, param₁ 1, param₂ are control parameters, and idx is an index number of the sub-contour. The smaller the index number is, the greater the probability of selecting that the sub-contour is not to be filled or to be filled by the random scatter filling is, so that the writing brush effect can be simulated more truly.

In some implementations, after the stroke contour is divided into the K sub-contours, and the part of sub-contours are selected from the K sub-contours to be filled, the rest of the sub-contours may be filled in another filling manner.

If full black filling is performed on the part of sub-contours, scatter filling is to be performed on the sub-contours except the part of sub-contours in the K sub-contours.

Alternatively, if scatter filling is performed on the part of sub-contours, full black filling is to be performed on the sub-contours except the part of sub-contours in the K sub-contours.

In implementations, after the stroke contour is divided into the K sub-contours, a part of sub-contours may be selected for full black filling, and scatter filling is to be performed on the rest of the sub-contours, or, a part of sub-contours is selected for scatter filling, and full black filling is to be performed on the rest of the sub-contours, which can also generate the half-dry stroke effect.

In some implementations, after determining the stroke contour corresponding to the track points according to the track point information of the track points, positions of the sub-contours to be filled may be reset, every after a preset number of track points are acquired, in the following manner: if the number of the acquired track points exceeds a preset track point number threshold, adjusting the position of the sub-contour on which pixel filling is to be performed. In implementations, for a product such as a handwriting tablet with high requirements on the writing delay, the hardware usually performs display interaction in a way of densely collecting track points plus locally refreshing, so that the moving distance between adjacent sampled points acquired by the algorithm is relatively small. In order to avoid a problem of unnatural drawn textures due to frequently changing textures to be filled during generating random filling effects, in the present disclosure, for a device such as a handwriting tablet, the position of the sub-contour to be filled is to be changed every a preset number of track points, for example, the position of the sub-contour is to be changed every ten track points.

In some implementations, if the number of the acquired track points exceeds the preset track point number threshold, positions of a preset number of sub-contours at the edge of the stroke contour, in the sub-contours on which pixel filling is to be performed, are adjusted. By adjusting the position of the sub-contour at the edge of the stroke contour, the texture change at the edge of the stroke contour, after two adjacent adjustments are performed, can be smoother.

For example, for changing the position of the sub-contour to be filled, in order to avoid the problem of “abrupt change” of the texture caused by a relatively great difference between settings of two adjacent black filling regions, the following rules may be adopted for texture filling: if the position of the sub-contour to be filled is generated for the first time, setting a black filling region by generating a random number array, and after the black filling region is obtained, setting a current random scatter filling region with the above rule; if the position of the sub-contour to be filled is to be changed next time, for the previous black filling region, randomly changing settings of one to two sub-contours at the edge part, if the third, fourth and fifth sub-contours are set for full black filling at the previous time, a reasonable drawing setting at the current time is that the second, third and fourth sub-contours are set for full black filling, after the black filling region is obtained, the random scatter filling region at the current time is set according to the above rule, such that intersection exists between stroke contours corresponding to the positions of different sub-contours to be filled, and so on. In a common handwriting tablet, a width of the coarsest drawing line of a writing pen does not exceed 20 pix, and in twenty split sub-contours set in the present disclosure, a maximum width of each sub-contour does not exceed 1 pix, so that drawing settings of one to two sub-contours being modified can ensure a smooth texture change in visual. As shown in FIG. 8, a display effect of a hand-written font with the half-dry stroke beautification according to the present disclosure is illustrated.

In some implementations, a method to improve the smooth transition effect of the half-dry stroke is further provided, and is specifically as follows: after acquiring the track point information of track points in the writing track of the user and before dividing the stroke contour into the K sub-contours, performing full color filling on a stroke contour of a stroke corresponding to first track points in the writing track, and performing scatter filling on a stroke contour of a stroke corresponding to second track points in the writing track; and determining the stroke contour of the stroke corresponding to the track points according to track point information of third track points in the writing track; dividing the stroke contour into the K sub-contours, and selecting a part of sub-contours from the K sub-contours to perform pixel filling on the part of sub-contours; and controlling the display screen to display the stroke. The first track points, the second track points, and the third track points each are a preset number of track points in the writing track, the second track points are acquired after the first track points are acquired, and the third track points are acquired after the second track points are acquired. The number of the first track points, the number of the second track points and the number of the third track points may be the same as or different from each other.

In the embodiment of the present disclosure, before determining to perform pixel filling on the part of sub-contours in the stroke contour, in order to make the transition from the full color filling effect to the half-dry stroke effect more natural, a transition from the full color filling to scatter filling to half-dry stroke filling (i.e., in the pixel filling performed on the part of sub-contours) may be performed before performing the pixel filling with the half-dry stroke effect, so that the transition from the full color filling to the half-dry stroke filling is more natural.

The full color filling in the embodiment of the present disclosure includes, but is not limited to, full black filling or any other color filling, which is not limited in the embodiment of the present disclosure.

The embodiment of the present disclosure may be applied to an ink screen reading tablet, and can help to reduce the handwriting delay in the interaction process, through a quick drawing method between sampled writing points. The track points and the writing pressures written by the user are acquired through an electromagnetic pen. A mapping formula for the line width at the writing track point is designed according to the writing pressure and the writing speed. During the user uses the device, the thickness of a written line can be ensured naturally changing without generating saw teeth, through the method of smoothing the line width. According to the present disclosure, a basic graph is drawn on each sampled point, and a connecting graph is drawn between adjacent basic graphs. After the writing speed and the writing pressure by the user reach preset conditions, the drawn graph is split, so that the “half-dry stroke” effect of the writing brush is realized, and more natural texture change can be realized during the user writing.

Based on the same inventive concept as above, an embodiment of the present disclosure further provides a handwriting display method, which may be applied to a display device, and specific implementation steps of the method may refer to the method in the display device described above, and repeated parts are not described again.

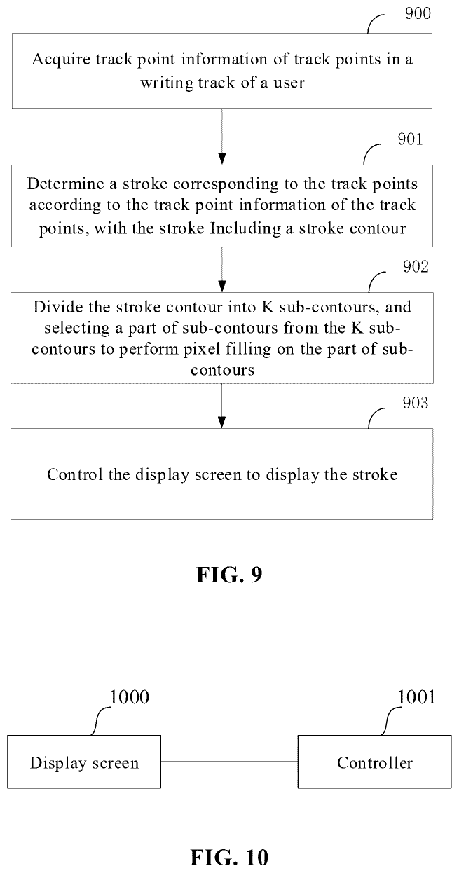

As shown in FIG. 9, the specific implementation flow of the method includes following steps 900 to 903.

At step 900, acquiring track point information of track points in a writing track of a user.

At step 901, determining a stroke corresponding to the track points according to the track point information of the track points, with the stroke including a stroke contour.

At step 902, dividing the stroke contour into K sub-contours, and selecting a part of sub-contours from the K sub-contours to perform pixel filling on the part of sub-contours, with an extending direction in which the stroke contour extends is the same as an extending direction in which the sub-contours extend, and K being an integer greater than 1.

At step 903, controlling a display screen to display the stroke.

In some implementations, there is at least one sub-contour on which pixel filling is not to be performed between at least two sub-contours on which pixel filling is to be performed.

In some implementations, the selecting a part of sub-contours from the K sub-contours to perform pixel filling on the part of sub-contours includes: randomly selecting a part of sub-contours from the K sub-contours to perform pixel filling on the part of sub-contours.

In some implementations, the selecting a part of sub-contours from the K sub-contours to perform pixel filling on the part of sub-contours, includes: selecting a part of sub-contours from the K sub-contours to perform pixel filling on the part of sub-contours, according to generated K random numbers and a corresponding relation between the random numbers and the sub-contours.

In some implementations, the selecting a part of sub-contours from the K sub-contours to perform pixel filling on the part of sub-contours, according to generated K random numbers and a corresponding relation between the random numbers and the sub-contours, includes: calculating a product value of an average value of the K random numbers and a half-dry stroke parameter, with the half-dry stroke parameter being configured to control the number of the sub-contours on which pixel filling is to be performed; if any random number is greater than the product value, determining to perform pixel filling on the sub-contour corresponding to the random number; and if any random number is less than or equal to the product value, determining not to perform pixel filling on the sub-contour corresponding to the random number.

In some implementations, the half-dry stroke parameter is determined according to a writing speed, and the half-dry stroke parameter is increased along with increase of the writing speed; and/or the half-dry stroke parameter is determined according to a writing pressure, and the half-dry stroke parameter is increased along with a decrease of the writing pressure.

In some implementations, the selecting a part of sub-contours from the K sub-contours to perform pixel filling on the part of sub-contours, includes: performing pixel filling on the part of sub-contours in different filling manners.

In some implementations, the performing pixel filling on the part of sub-contours in different filling manners, includes: performing pixel filling on the part of sub-contours in different filling manners alternately.

In some implementations, the performing pixel filling on the part of sub-contours in different filling manners alternately, includes: performing pixel filling on the part of sub-contours in a first filling manner and a second filling manner alternately.

In some implementations, the method further includes: dividing continuous sub-contours in the part of sub-contours selected into one contour group, to perform pixel filling on the sub-contours in the contour group at once in a same filling manner.

In some implementations, the performing pixel filling on the sub-contours in the contour group at once in a same filling manner, includes: randomly selecting a filling manner from different filling manners, to perform pixel filling on the sub-contours in the contour group in the selected filling manner.

In some implementations, the randomly selecting a filling manner from different filling manners, to perform pixel filling on the sub-contours in the contour group in the selected filling manner, includes: randomly selecting a filling manner from a plurality of filling manners with a same probability, to perform pixel filling on the sub-contours in the contour group at once in the selected filling manner; or randomly selecting a filling manner from a plurality of filling manners with different probabilities, to perform pixel filling on the sub-contours in the contour group at once in the selected filling manner, the filling manners are in one-to-one correspondence with the probabilities.

In some implementations, the determining the stroke contour of the stroke corresponding to the track points, includes: fitting coordinate information of the track points to obtain a fit curve; selecting a plurality of fit track points from the fit curve, with the plurality of fit track points including at least three first fit track points corresponding to the track points; determining a stroke contour of the plurality of fit track points according to coordinate information of the fit track points and a writing speed and a writing pressure at the track points corresponding to the first fit track points; and taking the stroke contour of the plurality of fit track points as the stroke contour corresponding to the track points.

In some implementations, the determining a stroke contour of the plurality of fit track points according to coordinate information of the fit track points and a writing speed and a writing pressure at the track points corresponding to the first fit track points, includes: determining a position of the stroke contour according to the coordinate information of the plurality of fit track points; and determining a width of the stroke contour according to the writing speed and the writing pressure at the track points corresponding to the first fit track points.

In some implementations, the determining a width of the stroke contour according to the writing speed and the writing pressure at the track points corresponding to the first fit track points, includes: determining a line width at the first fit track point according to a preset maximum line width, a preset minimum line width, a preset weight factor, and the writing speed and the writing pressure at the track point corresponding to the first fit track point, with the preset weight factor indicating a sensitivity parameter of a response adjustment of the line width for different factors; determining line widths at the fit track points based on interpolation operation according to the line widths at at least three first fit track points; and determining the width of the stroke contour according to the line widths at the fit track points.

In some implementations, after determining the line widths at the fit track points based on interpolation operation according to the line widths at at least three first fit track points, the method further includes: smoothing the line widths at the fit track points according to first line widths of history fit track points corresponding to history track points of the track points, to obtain smoothed line widths at the fit track points; the historical track points of the track points are a plurality of track points continuously received before receiving the track points; and the historical fit track points corresponding to the historical track points are coordinate points on a fit curve obtained by fitting the historical track points.

In some implementations, the smoothing the line widths at the fit track points according to first line widths of history fit track points corresponding to history track points of the track points, to obtain smoothed line widths at the fit track points, includes: determining the smoothed line widths at the fit track points according to the first line widths at the history fit track points, the line widths at the fit track points and a preset number of the history fit track points.

In some implementations, the selecting a part of sub-contours from the K sub-contours to perform pixel filling on the part of sub-contours, includes: dividing continuous sub-contours in the part of sub-contours into one contour group, to perform pixel filling on the sub-contours in the contour group at once in a same filling manner.

In some implementations, in the part of sub-contours selected, the number of the sub-contours on which pixel filling is to be performed continuously is less than a number threshold value; or in the part of sub-contours selected, the number of the sub-contours on which pixel filling is to be performed continuously in a same filling manner is less than a number threshold value.

In some implementations, a ratio of a total width of the sub-contours on which pixel filling is to be performed to a width of the stroke contour is decreased along with an increase of the writing speed at the track points; or a ratio of a total width of the sub-contours on which pixel filling is not to be performed to the width of the stroke contour is increased along with the increase of the writing speed at the track points.

In some implementations, a ratio of a total width of the sub-contours on which pixel filling is to be performed to a width of the stroke contour is increased along with an increase of the writing pressure at the track points; or a ratio of a total width of the sub-contours on which pixel filling is not to be performed to the width of the stroke contour is decreased along with the increase of the writing pressure at the track points.

In some implementations, the number of the sub-contours on which pixel filling is to be performed is decreased along with an increase of the writing speed at the track points; or the number of the sub-contours on which pixel filling is not to be performed is increased along with the increase of the writing speed at the track points.

In some implementations, the number of the sub-contours on which pixel filling is to be performed is increased along with an increase of the writing pressure at the track points; or the number of the sub-contours on which pixel filling is not to be performed is decreased along with the increase of the writing pressure at the track points.

In some implementations, a density of pixel filling in the stroke contour is decreased along with an increase of the writing speed at the track points; or a density without pixel filling in the stroke contour is increased along with the increase of the writing speed at the track points; the density of pixel filling indicates a ratio of the number of sub-contours to be filled to K.

In some implementations, a density of pixel filling in the stroke contour is increased along with ana increase of the writing pressure at the track points; or a density without pixel filling in the stroke contour is decreased along with the increase of the writing pressure at the track points; where the density of pixel filling indicates a ratio of the number of sub-contours to be filled to K.

In some implementations, if the filling manner of the sub-contour includes scatter filling, a probability corresponding to the scatter filling is configured to control the number of the sub-contour to be filled by the scatter filling; the probability corresponding to the scatter filling is increased along with an increase of the writing speed at the track points; and/or the probability corresponding to the scatter filling is decreased along with the increase of the writing pressure at the track points.

In some implementations, if the filling manner of the sub-contour includes scatter filling, a scatter density corresponding to the scatter filling is decreased along with an increase of the writing speed at the track points; and/or the scatter density corresponding to the scatter filling is increased along with the increase of the writing pressure at the track points.

In some implementations, if the stroke is a left-falling stroke, the further a position of the sub-contour in the stroke contour is to left, the less a probability of performing pixel filling on the sub-contour is; or the further the position of the sub-contour in the stroke contour is to right, the greater the probability of performing pixel filling on the sub-contour is.

In some implementations, if the filling manner of the sub-contour is scatter filling and the stroke is a left-falling stroke, the further a position of the sub-contour in the stroke contour is to left, the less a scatter density of scatter filling performed on the sub-contour is; or, the further the position of the sub-contour in the stroke contour to right, the greater the scatter density of scatter filling performed on the sub-contour is.

In some implementations, if the stroke is a right-falling stroke, the further a position of the sub-contour in the stroke contour is to right, the less a probability of performing pixel filling on the sub-contour is; or the further the position of the sub-contour in the stroke contour is to left, the greater the probability of performing pixel filling on the sub-contour is.

In some implementations, if the filling manner of the sub-contour is scatter filling and the stroke is a right-falling stroke, the further a position of the sub-contour in the stroke contour is to right, the less a scatter density of scatter filling performed on the sub-contour is; or the further the position of the sub-contour in the stroke contour is to left, the greater the scatter density of scatter filling performed on the sub-contour is.

In some implementations, the dividing the stroke contour into K sub-contours, includes: if a writing speed at the track points is greater than a speed threshold value and/or a writing pressure at the track points is less than a pressure threshold value, dividing the stroke contour into the K sub-contours.

In some implementations, the method further includes: if the number of the track points acquired exceeds a preset track point number threshold, adjusting a position of the sub-contour on which pixel filling is to be performed.

In some implementations, the adjusting a position of the sub-contour on which pixel filling is to be performed, includes: adjusting positions of a preset number of sub-contours at an edge of the stroke contour, in the sub-contours on which pixel filling is to be performed.

Based on the same inventive concept as above, as shown in FIG. 10, an embodiment of the present disclosure further provides a display device, which includes a display screen 1000 and a controller 1001.

The display screen 1000 is configured to display a content.

The controller 1001 is configured to: acquire track point information of track points in a writing track of a user; determine a writing speed, a writing pressure corresponding to the track points and coordinates of the track points, according to the track point information of the track points; determining line widths corresponding to the track points according to the writing speed and the writing pressure corresponding to the track points; and determining a stroke contour corresponding to the track points, according to the line widths corresponding to the track points and the coordinates of the track points.

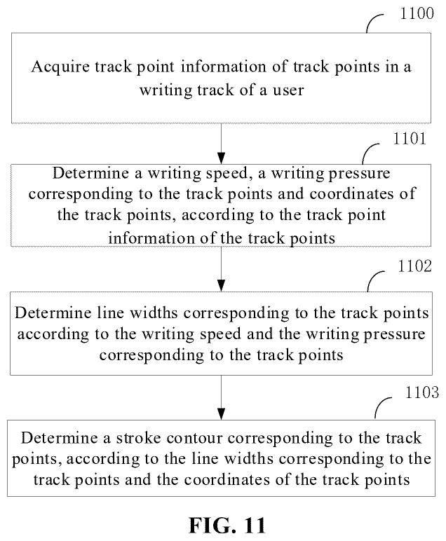

Based on the same inventive concept as above, as shown in FIG. 11, an embodiment of the present disclosure further provides a handwriting contour determination method, and the specific implementation flow of the method includes following steps 1100 to 1103.

At step 1100, acquiring track point information of track points in a writing track of a user.

At step 1101, determining a writing speed, a writing pressure corresponding to the track points and coordinates of the track points, according to the track point information of the track points.

At step 1102, determining line widths corresponding to the track points according to the writing speed and the writing pressure corresponding to the track points.

At step 1103, determining a stroke contour corresponding to the track points, according to the line widths corresponding to the track points and the coordinates of the track points.

Based on the same inventive concept as above, an embodiment of the present disclosure further provides a handwriting display apparatus, and specific implementation steps of the apparatus may refer to the display device described above, and repeated parts are not described again.

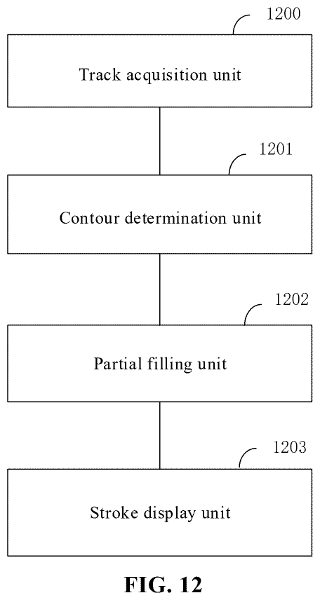

As shown in FIG. 12, the apparatus includes: a track acquisition unit 1200, configured to acquire track point information of track points in a writing track of a user; a contour determination unit 1201, configured to determining a stroke corresponding to the track points according to the track point information of the track points, with the stroke including a stroke contour; a partial filling unit 1202, configured to divide the stroke contour into K sub-contours, and select a part of sub-contours from the K sub-contours to perform pixel filling on the part of sub-contours, with an extending direction in which the stroke contour extends being the same as an extending direction in which the sub-contours extend, and K being an integer greater than 1; and a stroke display unit 1203, configured to control a display screen to display the stroke.

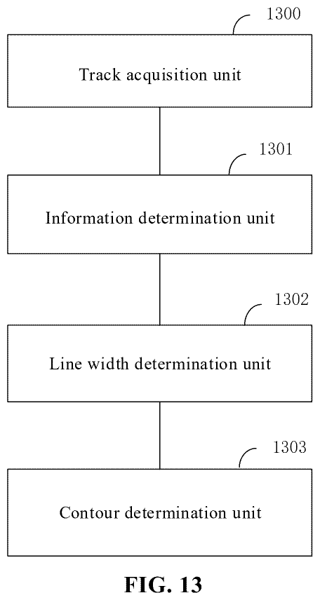

Based on the same inventive concept as above, an embodiment of the present disclosure further provides a handwriting contour determination apparatus. As shown in FIG. 13, the apparatus includes: a track acquisition unit 1300, configured to acquire track point information of track points in a writing track of a user; an information determination unit 1301, configured to determine a writing speed, a writing pressure corresponding to the track points and coordinates of the track points, according to the track point information of the track points; a line width determination unit 1302, configured to determine line widths corresponding to the track points, according to the writing speed and the writing pressure corresponding to the track point; and a contour determination unit 1303, configured to determine a stroke contour corresponding to the track points, according to the line widths corresponding to the track points and the coordinates of the track points.

Based on the same inventive concept as above, an embodiment of the present disclosure provide a computer-readable storage medium, which stores computer program codes, the computer program codes, run by a computer, causes the computer to perform any one of the handwriting display method or the handwriting determination method as discussed in the foregoing. Since the principle of solving the problem of the computer-readable storage medium is similar to that of the handwriting display method or the handwriting contour determination method, the implementation of the computer-readable storage medium may refer to the implementation of the method, and repeated parts are not described again.

In particular implementations, the computer-readable storage medium may include a Universal Serial Bus Flash Drive (USB), a removable hard disk, a Read-Only Memory (ROM), a Random Access Memory (RAM), a magnetic disk, or an optical disk, or other storage medium capable of storing program codes.

Based on the same inventive concept as above, an embodiment of the present disclosure further provide a computer program product, which includes computer program codes, the computer program codes, run by a computer, causes the computer to perform any one of the handwriting display method or the handwriting contour determination method as discussed in the foregoing. Since the principle of solving the problem of the computer program product is similar to that of the handwriting display method or the handwriting contour determination method, the implementation of the computer program product may refer to the implementation of the method, and repeated parts are not described again.

The computer program product may employ any combination of one or more readable medium. The readable medium may be a readable signal medium or a readable storage medium. The readable storage medium may be, for example, but not limited to, an electronic, magnetic, optical, electromagnetic, infrared, or semiconductor system, apparatus, or device, or a combination of any of the foregoing. More specific examples (a non-exhaustive list) of the readable storage medium include: an electrical connection having one or more wires, a portable diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the foregoing.

As will be appreciated by those skilled in the art, embodiments of the present disclosure may be provided as a method, a system, or a computer program product. Accordingly, the present disclosure may take the form of an entirely hardware embodiment, an entirely software embodiment or an embodiment combining software and hardware aspects. Furthermore, the present disclosure may take the form of a computer program product which is embodied on one or more computer-usable storage medium (including, but not limited to, disk storage, optical storage, and the like) having computer-usable program code embodied therein.

The present disclosure is described with reference to flowcharts and/or block diagrams of methods, devices (systems), and computer program products according to the embodiments of the present disclosure. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing device to produce a machine instruction, such that the instructions, which are executed via the processor of the computer or other programmable data processing device, create a device for implementing the functions specified in a flow or flows in the flowchart and/or a block or blocks in the block diagram.

These computer program instructions may also be stored in a computer-readable memory that can direct a computer or other programmable data processing device to function in a particular manner, such that the instructions stored in the computer-readable memory produce an article of manufacture including instruction device which implement the function specified in a flow or flows in the flowchart and/or a block or blocks in the block diagram.

These computer program instructions may also be loaded onto a computer or other programmable data processing device to cause a series of operational steps to be performed on the computer or other programmable device to produce a computer implemented process, such that the instructions which are executed on the computer or other programmable device provide steps for implementing the functions specified in a flow or flows in the flowchart and/or a block or blocks in the block diagram.

It will be apparent to those skilled in the art that various changes and variations may be made to the present disclosure without departing from the spirit and scope of the present disclosure. Thus, if such modifications and variations to the present disclosure are within the scope of the claims of the present disclosure and their equivalents, the present disclosure is also intended to encompass such modifications and variations.

1. A display device, comprising a display screen and a controller, wherein
the display screen is configured to display a content; and
the controller is configured to:
acquire track point information of track points in a writing track of a user;
determine a stroke corresponding to the track points according to the track point information of the track points, with the stroke comprises a stroke contour;
divide the stroke contour into K sub-contours, and selecting a part of sub-contours from the K sub-contours to perform pixel filling on the part of sub-contours, with an extending direction in which the stroke contour extends being the same as an extending direction in which the sub-contours extend, and K being an integer greater than 1; and
control the display screen to display the stroke.

2. The device according to claim 1, wherein there is at least one sub-contour on which pixel filling is not to be performed between at least two sub-contours on which pixel filling is to be performed.

3. The device according to claim 1, wherein the controller is configured to:
randomly select a part of sub-contours from the K sub-contours to perform pixel filling on the part of sub-contours: or
select a part of sub-contours from the K sub-contours to randomly perform pixel filling on the part of sub-contours.

4. The device according to claim 1, wherein the controller is configured to:
select a part of sub-contours from the K sub-contours to perform pixel filling on the part of sub-contours, according to generated K random numbers and a corresponding relation between the random numbers and the sub-contours.

5. The device according to claim 4, wherein the controller is configured to:
calculate a product value of an average value of the K random numbers and a half-dry stroke parameter, with the half-dry stroke parameter being configured to control a total number of the sub-contours on which pixel filling is to be performed;
in response to any random number is greater than the product value, determine to perform pixel filling on the sub-contour corresponding to the random number; and
in response to that any random number is less than or equal to the product value, determine not to perform pixel filling on the sub-contour corresponding to the random number,
wherein the half-dry stroke parameter is determined according to a writing speed, wherein the half-dry stroke parameter is increased along with an increase of the writing speed; and/or
the half-dry stroke parameter is determined according to a writing pressure, and the half-dry stroke parameter is increased along with a decrease of the writing pressure.

6-7. (canceled)

8. The device according to claim 1, wherein the controller is configured to:
perform pixel filling on the part of sub-contours selected in different filling manners alternately.

9. (canceled)

10. The device according to claim 8, wherein the controller is further configured to:
divide continuous sub-contours in the part of sub-contours selected into one contour group, to perform pixel filling on the sub-contours in the contour group at once in a same filling manner.

11. (canceled)

12. The device according to claim 10, wherein the controller is configured to: randomly select a filling manner from a plurality of filling manners with a same probability, to perform pixel filling on the sub-contours in the contour group at once in the filling manner: or
randomly select a filling manner from a plurality of filling manners with different probabilities, to perform pixel filling on the sub-contours in the contour group at once in the filling manner, wherein the filling manners are in one-to-one correspondence with the probabilities.

13. The device according to claim 1, wherein the controller is configured to determine the stroke contour of the stroke corresponding to the track points by:
fitting coordinate information of the track points to obtain a fit curve;
selecting a plurality of fit track points from the fit curve, with the plurality of fit track points comprising at least three first fit track points corresponding to the track points;
determining a stroke contour of the plurality of fit track points according to coordinate information of the fit track points and a writing speed and a writing pressure at the track points corresponding to the first fit track points; and
taking the stroke contour of the plurality of fit track points as the stroke contour corresponding to the track points.

14. The device according to claim 13, wherein the controller is configured to, according to the coordinate information of the plurality of fit track points and the writing speed and the writing pressure at the track points corresponding to the first fit track points:
determine a position of the stroke contour according to the coordinate information of the plurality of fit track points; and
determine a width of the stroke contour according to the writing speed and the writing pressure at the track points corresponding to the first fit track points.

15. The device according to claim 14, wherein the controller is configured to: determine a line width at a first fit track point according to a preset maximum line width, a preset minimum line width, a preset weight factor, and the writing speed and the writing pressure at the track point corresponding to the first fit track point, with the preset weight factor indicating a sensitivity parameter of a response adjustment of the line width for different factors:
determine line widths at the fit track points based on interpolation operation according to line widths at at least three first fit track points; and
determining the width of the stroke contour according to the line widths at the fit track points,
wherein after determining the line widths at the fit track points based on the interpolation operation according to the line widths at at least three first fit track points, the controller is further configured to:
smooth the line widths at the fit track points according to first line widths of history fit track points corresponding to history track points of the track points, to obtain smoothed line widths at the fit track points, with the historical track points of the track points being a plurality of track points continuously received before receiving the track points, and the historical fit track points corresponding to the historical track points being coordinate points on a fit curve obtained by fitting the historical track points,
wherein the controller is configured to:
determine the smoothed line widths at the fit track points according to the first line widths at the history fit track points, the line widths at the fit track points and a preset number of the history fit track points.

16-18. (canceled)

19. The device according to claim 1, wherein,
in the part of sub-contours selected, a total number of the sub-contours on which pixel filling is to be performed continuously is less than a number threshold value; or
in the part of sub-contours selected, a total number of the sub-contours on which pixel filling is to be performed continuously in a same filling manner is less than a number threshold value.

20. The device according to claim 1, wherein a ratio of a total width of the sub-contours on which pixel filling is to be performed to a width of the stroke contour is decreased along with an increase of the writing speed at the track points; or
a ratio of a total width of the sub-contours on which pixel filling is not to be performed to the width of the stroke contour is increased along with the increase of the writing speed at the track points; or
a ratio of a total width of the sub-contours on which pixel filling is to be performed to a width of the stroke contour is increased along with an increase of the writing pressure at the track points; or
a ratio of a total width of the sub-contours on which pixel filling is not to be performed to the width of the stroke contour is decreased along with the increase of the writing pressure at the track points.

21. (canceled)

22. The device according to claim 1, wherein a total number of the sub-contours on which pixel filling is to be performed is decreased along with an increase of the writing speed at the track points: or
a total number of the sub-contours on which pixel filling is not to be performed is increased along with the increase of the writing speed at the track points; or
a total number of the sub-contours on which pixel filling is to be performed is increased along with an increase of the writing pressure at the track points; or
a total number of the sub-contours on which pixel filling is not to be performed is decreased along with the increase of the writing pressure at the track points.

23. (canceled)

24. The device according to claim 1, wherein a density of pixel filling in the stroke contour is decreased along with an increase of the writing speed at the track points: or
a density without pixel filling in the stroke contour is increased along with the increase of the writing speed at the track points: or
a density of pixel filling in the stroke contour is increased along with an increase of the writing pressure at the track points; or
a density without pixel filling in the stroke contour is decreased along with the increase of the writing pressure at the track points;
wherein the density of pixel filling indicates a ratio of a total number of the sub-contours to be filled to K.

25. (canceled)

26. The device according to claim 1, wherein in response to that a filling manner of the sub-contour comprises scatter filling, a probability corresponding to the scatter filling is configured to control a total number of the sub-contour to be filled by scatter filling; and
the probability corresponding to the scatter filling is increased along with an increase of the writing speed at the track points; and/or
the probability corresponding to the scatter filling is decreased along with the increase of the writing pressure at the track points; and/or
a scatter density corresponding to the scatter filling is decreased along with an increase of the writing speed at the track points; and/or
the scatter density corresponding to the scatter filling is increased along with the increase of the writing pressure at the track points.

27. (canceled)

28. The device according to claim 1, wherein in response to that the stroke is a left-falling stroke, the further a position of the sub-contour in the stroke contour is to left, the less a probability of performing pixel filling on the sub-contour is: or
the further the position of the sub-contour in the stroke contour is to right, the greater the probability of performing pixel filling on the sub-contour is,
in response to that a filling manner of the sub-contour is scatter filling and the stroke is a left-falling stroke,
the further a position of the sub-contour in the stroke contour is to left, the less a scatter density of scatter filling performed on the sub-contour is; or,
the further the position of the sub-contour in the stroke contour to right, the greater the scatter density of scatter filling performed on the sub-contour is.

29. (canceled)

30. The device according to claim 1, wherein in response to that the stroke is a right-falling stroke, the further a position of the sub-contour in the stroke contour is to right, the less a probability of performing pixel filling on the sub-contour is: or
the further the position of the sub-contour in the stroke contour is to left, the greater the probability of performing filling on the sub-contour is,
in response to that a filling manner of the sub-contour is scatter filling and the stroke is a right-falling stroke, the further a position of the sub-contour in the stroke contour is to right, the less a scatter density of scatter filling performed on the sub-contour is; or
the further the position of the sub-contour in the stroke contour is to left, the greater the scatter density of scatter filling performed on the sub-contour is.

31. (canceled)

32. The device according to claim 1, wherein the controller is configured to
in response to that a writing speed at the track points is greater than a speed threshold value and/or a writing pressure at the track points is less than a pressure threshold value, divide the stroke contour into the K sub-contours.

33. The device according to claim 1, wherein the controller is further configured to:
in response to that a total number of the track points acquired exceeds a preset track point number threshold, adjust a position of the sub-contour on which pixel filling is to be performed,
wherein the controller is configured to:
adjust positions of a preset number of sub-contours at an edge of the stroke contour, in the sub-contours on which pixel filling is to be performed.

34-38. (canceled)
